(19) United States
(12) Patent Application Publication
(10) Pub. No.: US 2015/0037674 A1
(43) Pub. Date: Feb. 5, 2015

(54) ELECTRODE MATERIAL FOR LITHIUM-BASED ELECTROCHEMICAL ENERGY STORES

(71) Applicant: WESTFÄLISCHE WILHELMS-UNIVERSITÄT MÜNSTER, MÜNSTER (DE)

(72) Inventors: Dominic Bresser, Ulm (DE); Elie Paillard, Munster (DE); Martin Winter, Munster (DE); Stefano Passerini, Munster (DE)

(21) Appl. No.: 14/379,977

(22) PCT Filed: Feb. 22, 2013
(86) PCT No.: PCT/EP2013/053541

§ 371 Date: Aug. 20, 2014

(30) Foreign Application Priority Data
Feb. 23, 2012 (DE) 10 2012 101 457.4

(51) Int. Cl. H01M 4/36; H01M 4/1391; H01M 10/0525; H01M 4/04; H01M 4/62; H01M 6/14

(52) U.S. Cl. CPC H01M 4/366; H01M 4/625; H01M 4/621; H01M 6/14; H01M 10/0525; H01M 4/0402; H01M 4/0471; H01M 4/1391; H01M 2220/20; H01M 2220/10
USPC 429/221; 427/122

(57) ABSTRACT

The invention relates to carbon-coated zinc ferrite particles, to a method for producing carbon-coated zinc ferrite particles, and to the use thereof as the electrode material for lithium-ion batteries.

The invention relates to a method for producing electrode material for lithium-ion batteries. The invention relates more particularly to carbon-coated zinc ferrite particles, to a method for producing carbon-coated zinc ferrite particles, and to the use thereof as electrode material for lithium-ion batteries.

Lithium-ion batteries currently constitute the leading technology within the field of rechargeable batteries, and they dominate the battery market for portable electronics. Applications for lithium-ion batteries in electrical vehicles or in storage technologies for wind or solar energy, for example, nevertheless necessitate the development of rechargeable battery technologies having significantly higher specific energies than have hitherto been available commercially or at all.

The anode material of the majority of commercially available lithium-ion batteries is presently based on graphite. There have also been proposals of transition metal oxides as new electrode materials, whose reversible electrochemical reactions with lithium exhibit a significantly increased volumetric and gravimetric capacity by comparison with graphite. The metal oxide Fe₃O₄, for example, would be cost-effective and also eco-friendly, having a health classification very largely of “safe”. Proposals have also been made for partial replacement of iron by other metals able to enter reversibly into an alloy with lithium. One possibility in this context is afforded by the doping of Fe₃O₄ with zinc, which is able to react electrochemically with lithium to form ZnLi. Moreover, JP 2000243392 A discloses the production of a lithium-containing electrode material for cathodes, based on ZnFe₂O₄ as starting material, for example.

It is nevertheless assumed that electrodes on this basis can be charged and discharged only very slowly unless large capacity losses are accepted. This is a great disadvantage, especially for subsequent application of these materials in batteries for automobiles, since the rapid rechargeability (“filling up”) is massively important not only generally but also, in particular, for rapid acceleration and braking. In addition, structural changes in the electrode material that occur as part of the underlying conversion reaction, induced by severe alterations in volume, give these electrodes only limited lifetime and a low cycling stability, brought about more particularly by the attendant loss in electronic contact between active material and current collector.

A further disadvantage is that the capacity of ZnFe₂O₄ decreases over the course of cycles. Corresponding electrodes, moreover, display a decreasing capacity for shortened charge and discharge times and/or increased applied current densities.

It was an object of the present invention, accordingly, to provide an electrode material and a method for producing a material that is suitable for use as electrode material with sufficient cycling stability in a lithium-ion battery.

This object is achieved by means of carbon-coated zinc ferrite particles wherein the weight ratio of zinc ferrite to carbon is in the range from ≧75:25 to ≦99:1, preferably in the range from ≧80:20 to ≦98:2, more preferably in the range from ≧85:15 to ≦95:5.

Surprisingly it has been found that electrodes formed from carbon-coated zinc ferrite particles of the invention display a significantly improved cycling capacity. An improved number of cycles leads in particular to more long-lived electrodes. Furthermore, the electrodes display a slightly increased capacity. A particular advantage is that the electrodes exhibit a significantly improved electrochemical performance for applied high current densities, in other words displaying significantly increased charge and discharge speeds. Particularly advantageous in this context is a full recovery of the original capacity following increased applied current densities.

The term “particle” is used herein synonymous to “particle.”

The term “zinc ferrite” is used in the sense of the present invention to refer to iron oxide compounds doped with zinc. The ratio of Zn to Fe in such compounds may be in the region of 0.5:2.5, preferably in the region of 1:2. A higher fraction of Zn is generally preferred on account of the increased theoretical capacity. A suitable zinc ferrite is ZnFe₂O₄. Zinc ferrite is advantageously an eco-friendly and very largely biocompatible material.

The carbon coating of the zinc ferrite particles has the advantageous effect of raising the electronic conductivity of the material. In preferred embodiments the fraction of carbon, based on the total weight of the carbon-coated zinc ferrite particles, is in the range from ≧1 wt % to ≦25 wt %, preferably in the range from ≧2 wt % to ≦20 wt %, more preferably in the range from ≧5 wt % to ≦15 wt %. Within these ranges in particular it is possible to achieve good or very good charge states of the active material even in the case of a very applied high current density to the electrodes.

The carbon-coated zinc ferrite particles preferably have a BET surface area in the range from ≧0.1 m²/g to ≦200 m²/g, preferably in the range from ≧10 m²/g to ≦150 m²/g, more preferably in the range from ≧50 m²/g to ≦100 m²/g. The BET surface area may be determined by determining the specific surface area of solids by means of gas adsorption by the Brunauer-Emmett-Teller (BET) method by means of the adsorption of nitrogen. The BET surface area may for example be 85 m²/g.

The particles preferably have a size in the nanometer range. Preferably the particles have a spherical or ball-shaped form. Spherical particles have the advantage of permitting effective contact as electrode material. Nanoparticles with spherical form in the sense of the present invention are spherical structures having a size in the nanometer range, more particularly nanospheres and what are called nanodots. The carbon-coated zinc ferrite particles preferably have an average diameter in the range from ≧5 nm to ≦1000 nm, preferably in the range from ≧20 nm to ≦500 nm, more preferably in the range from ≧25 nm to ≦100 nm. The term “average diameter” refers to the average value of all diameters or arithmetically averaged diameters, relative to all particles. Advantageously, particles having a size in the nanometer range are able to provide a low particle size and a high specific surface area. This permits a high contact area of the particles with an electrolyte, and hence a high number of possible reaction sites with the Li⁺ ions present in the electrolyte.

Alternatively, particles having a size in the nanometer range may exhibit cylindrical structure. Cylindrical structures may also be termed one-dimensional nanostructures, more particularly those known as nanorods, nanowires, nanotubes, and nanofibers. Carbon-coated zinc ferrite particles with a cylindrical nanostructure preferably have an average diameter in the range from ≧3 nm to ≦250 nm and an average length in the range from ≧10 nm to ≦10 μm, preferably an average diameter in the range from ≧5 nm to ≦100 nm and an average length in the range from ≧30 nm to ≦1 μm, more preferably an average diameter in the range from ≧10 nm to ≦30 nm and an average length in the range from ≧50 nm to ≦300 nm. The term “average length” refers to the average value of the lengths or to the arithmetically averaged length, relative to all particles.

A further aspect of the present invention relates to a method for producing carbon-coated zinc ferrite particles, comprising the following steps:

a) mixing zinc ferrite particles with a sugar, and
b) carbonizing the mixture from step a).

The method is more particularly a method for producing an electrode material, more particularly for lithium-based energy storage devices, comprising carbon-coated zinc ferrite particles.

Starting material used is preferably ZnFe₂O₄. Zinc ferrite particles that can be used preferably have a size in the nanometer range. Techniques for producing useful nanostructured zinc ferrite particles, such as sol-gel methods, combustion methods, methods involving direction by surface ligands, flame pyrolysis, ultrasonic spray pyrolysis, hydrothermal methods or solid-phase methods, are known to the skilled person. ZnFe₂O₄ as starting material is commercially available. The method, moreover, can be transposed easily and without substantial cost and complexity to the industrial scale.

The carbonizing of the sugar in step b) of the method allows a carbon coating to be formed on the surface of the zinc ferrite particles. The term “carbonizing” in the sense of the present invention refers to the conversion of a carbon source, for example a sugar as carbon-containing starting material, into a carbon-containing residue in the absence of oxygen or hydrogen. In this way it is possible to form zinc ferrite particles coated with carbon.

The method using sugar provides in particular a mild method for the coating of zinc ferrite particles with carbon. Moreover, size and shape of the zinc ferrite particles can be largely retained. The process, moreover, has the advantage of releasing only nontoxic CO₂.

The use of sugar as carbon source, and the fraction of carbon finally remaining on the zinc ferrite particles, in the form of a carbon coating, lead advantageously to a significant increase in the electronic conductivity of the material. This is a great advantage especially for subsequent use as electrode material in lithium-ion batteries, since as a result of this it is possible to obtain very good to good charge states of the active material even in the case of very applied high current densities. Carbon coating, furthermore, may prevent agglomeration of the particles during electrode production and also during subsequent charging and discharging operations. Furthermore, the carbon coating may provide a buffer function for the changes in volume that occur during the charging and discharging operations. Carbon coating may also ensure electronic contact of the particles with one another and also, ultimately, with the current collector.

The zinc ferrite particles are preferably coated with amorphous carbon. A particular advantage is that the carbon coating is permeable to the liquid electrolyte, in order to ensure transport of the lithium-ions to the active material.

In preferred embodiments the sugar is a mono-, di- or polysaccharide, more particularly selected from the group comprising glucose, fructose, sucrose, lactose, starch, cellulose and/or derivatives thereof. Sugar is a favorable carbon source. Preference is given in particular to sucrose, also called saccharose, the most frequently occurring disaccharide. Sugars have the advantage, moreover, of a ready solubility in water. The water-soluble di- or monosaccharides such as sucrose and lactose and also glucose and fructose are therefore preferred. Alternatively it is also possible to use polysaccharides such as starch or cellulose. Cellulose, for example, dissolves well in ionic liquids.

Preferred sugars are selected from the group comprising glucose, fructose and/or sucrose. An especially preferred sugar is sucrose. It has been found that the use of sucrose as reactant in the carbonization led to a homogeneous and uniform coating of the particles with carbon. Sucrose is therefore especially suitable for coating zinc ferrite particles with carbon.

A particular advantage is that sucrose can be converted into amorphous carbon. Amorphous carbon not only possesses a high electronic conductivity but at the same time is permeable to the electrolyte and to the lithium-ions. Amorphous carbon, moreover, is especially suitable for accommodating volume expansion of the particles during the charging and discharging operation.

The zinc ferrite particles are mixed with the sugar in step a) preferably in a solvent. The solvent is preferably water, but may also be an ionic liquid. For example, the sugar may be dissolved in the solvent, the zinc ferrite particles added subsequently and dispersed with the sugar in solution in the solvent. The term “dispersing” is understood as the mixing of at least two substances which exhibit no or virtually no dissolution in one another or chemical bonding with one another—for example, the distribution of zinc ferrite particles as disperse phase in a sugar solution as continuous phase. Preference is given to a distribution of the zinc ferrite particles as uniform as possible in an aqueous sugar solution, in order to obtain maximally uniform wetting of the zinc ferrite particles with the sugar. The dispersing may be performed, for example, during a period of 1 to 2 hours, as for example for 1.5 hours, in a ball mill.

The sugar is dissolved preferably in small amounts of water, in order to give a viscous solution. Sugar and zinc ferrite particles, as for example sucrose and ZnFe₂O₄, are used preferably in a mass ratio of 1:1 to 1:10.

The mixture from step a) is preferably dried before the carbonizing step. In this way it is possible to dehydrate the sugar. The drying is performed preferably at a temperature in the range from ≧18° C. to ≦100° C., more preferably in the range from ≧20° C. to ≦80° C., preferably in the range from ≧23° C. to ≦460° C. The drying may be performed in particular at ambient temperature, as in the range from ≧18° C. to ≦23° C., for example. Drying may be performed in air. The dried mixture optionally may subsequently be ground or pulverized, in a mortar, for example. By this means it is possible for sugar-wetted particles which have stuck to one another or formed lumps as a result of the drying to be parted from one another again.

In step b) of the method, the mixture from step a) is carbonized. The carbonizing forms a carbon coating on the zinc ferrite particles. The carbonizing is preferably performed in an inert gas atmosphere, of argon, nitrogen or mixtures thereof, for example. As a result of this, unwanted secondary reactions such as oxidation of the carbon coating can be avoided.

In preferred embodiments, the carbonizing is performed at a temperature in the range from ≧350° C. to ≦700° C., preferably in the range from ≧400° C. to ≦600° C., more preferably in the range from ≧450° C. to ≦550° C. With further preference the carbonizing is performed at a temperature, for example, in the range from ≧400° C. to ≦500° C. In the case of mild carbonizing, at a temperature in the range from ≧450° C. to ≦550° C., an advantage is that reduction of the starting material to the pure metal can be avoided.

In particular in the case of use of sucrose, it is preferred for the carbonizing to be performed at a temperature in the range from ≧400° C. to ≦500° C., preferably in the range from ≧450° C. to ≦500° C. At these temperatures, when using sucrose, a particularly good carbonizing outcome can be obtained.

The carbonizing may be performed, for example, for a time in the range from ≧1 h to ≦24 h, preferably in the range from ≧2 h to ≦12 h, more preferably in the range from ≧3 h to ≦6 h. After the carbonizing, the resulting carbon-coated zinc ferrite particles can be ground or pulverized, by means of mortars, for example.

In preferred embodiments, the method is a method for producing an electrode material comprising carbon-coated zinc ferrite particles, comprising the following steps: a) mixing of zinc ferrite particles with a sugar, and

b) carbonizing of the mixture from step a). The method may provide a possibility for producing electrode material with no need for high temperatures, long reaction times, and a large number of reaction steps.

Overall the method is cost-effective and does not necessitate costly and inconvenient apparatus, meaning that industrial application as well is rapidly and easily feasible.

The carbon-coated zinc ferrite particles can be used in particular as electrode material for the production of anodes for lithium-ion batteries.

A further subject of the invention relates to carbon-coated zinc ferrite particles obtainable by a method of the invention. The carbon-coated zinc ferrite particles obtainable with the method of the invention are notable, as active material in electrodes, for a significantly improved cycling stability on the part of the electrodes produced from them. Moreover, the electrodes display a slightly increased capacity. A particular advantage is that the electrodes exhibit a significantly improved electrochemical performance for applied high current densities, in other words significantly increased charge and discharge speeds.

Particularly advantageous in this context is complete recovery of the original capacity following increased applied current densities. Even within the potential range utilized, furthermore, the carbon coating is electrochemically active and is able to store lithium-ions.

The weight ratio of zinc ferrite to carbon is preferably in the range from ≧75:25 to ≦99:1, preferably in the range from ≧80:20 to ≦98:2, more preferably in the range from ≧85:15 to ≦95:5. The fraction of carbon, based on the total weight of the carbon-coated zinc ferrite particles, is preferably in the range from ≧1 wt % to ≦25 wt %, preferably in the range from ≧2 wt % to ≦20 wt %, more preferably in the range from ≧5 wt % to ≦15 wt %.

The carbon-coated zinc ferrite particles preferably have a BET surface area in the range from ≧0.1 m²/g to ≦200 m²/g, preferably in the range from ≧10 m²/g to ≦150 m²/g, more preferably in the range from ≧50 m²/g to ≦100 m²/g. The BET surface area may for example be 85 m²/g.

The particles preferably have a size in the nanometer range. The particles preferably have a spherical shape. The carbon-coated zinc ferrite particles preferably have an average diameter in the range from ≧5 nm to ≦1000 nm, more preferably in the range from ≧20 nm to ≦500 nm, more preferably in the range from ≧25 nm to ≦100 nm. Alternatively the particles may have a cylindrical structure. Carbon-coated zinc ferrite particles with a cylindrical nanostructure preferably have an average diameter in the range from ≧3 nm to ≦250 nm and an average length in the range from ≧10 nm to ≦10 μm, preferably an average diameter in the range from ≧5 nm to ≦100 nm and an average length in the range from ≧30 nm to ≦1 μm, more preferably an average diameter in the range from ≧10 nm to ≦30 nm and an average length in the range from ≧50 nm to ≦300 nm.

The invention relates further to the use of carbon-coated zinc ferrite particles of the invention, or of carbon-coated zinc ferrite particles produced in accordance with the method of the invention, as electrode material, more particularly for lithium-based energy storage devices. A further subject of the invention relates to electrode material more particularly for lithium-based energy storage devices comprising carbon-coated zinc ferrite particles of the invention or carbon-coated zinc ferrite particles produced in accordance with the method of the invention.

A further subject of the invention relates to an electrode comprising carbon-coated zinc ferrite particles of the invention or carbon-coated zinc ferrite particles produced in accordance with the method of the invention.

The electrode comprising carbon-coated zinc ferrite particles of the invention or carbon-coated zinc ferrite particles produced in accordance with the invention is distinguished by a significantly improved cycling stability. Moreover, the electrodes display a slightly increased capacity. A particular advantage is that the electrodes exhibit a significantly improved electrochemical performance for applied high current densities, in other words significantly increased charge and discharge speeds. Particularly advantageous in this context is full recovery of the original capacity following increased applied current densities.

For the description of the carbon-coated zinc ferrite particles of the invention or carbon-coated zinc ferrite particles produced in accordance with the invention, reference is made to the description above. The carbon-coated zinc ferrite particles form the material in the electrode that reversibly takes up and gives up lithium, typically referred to as active material. This material may further comprise binder and additives. Accordingly, the active material of an electrode may be formed of or consist substantially of carbon-coated zinc ferrite particles of the invention. The active material is usually applied to a metal foil, such as a copper foil or aluminum foil, for example, or to a carbon-based current collector foil which acts as a current collector. Since the active material accounts for the substantial part of the electrode, the electrode may in particular also be formed of or based on carbon-coated zinc ferrite particles of the invention.

An electrode of this kind is commonly referred to as a composite electrode. In preferred embodiments the electrode is a composite electrode comprising carbon-coated zinc ferrite particles of the invention, binder, and optionally conductive carbon.

A particular advantage is that there is no need to use additional carbon for producing an electrode. Advantageously, the carbon network of the carbon-coated zinc ferrite particles is able to provide sufficient electrical conductivity on the part of the electrode.

The carbon cladding, furthermore, may prevent physical contact between the processed zinc ferrite particles, and may therefore actively counteract particle agglomeration during electrode production and in the course of cycling. The carbon coating may function, furthermore, as a buffer for the volume expansion and volume reduction that take place in the course of lithiation and delithiation. As a result, the cycling stability of the electrode can be increased. More particularly it is possible to achieve a higher attainable number of cycles with virtually constant capacity.

Provision may be made, however, to add further carbon for producing an electrode. This allows the conductivity of the electrode to be increased further. Carbon may also be added before the carbonizing of the mixture of the zinc ferrite particles with the sugar, and may already be dispersed, for example, together with the zinc ferrite particles in the sugar in solution in the solvent. For the production of an electrode, carbon is preferably added only to the carbon-coated zinc ferrite particles. Conductive carbon can preferably be added to the carbon-coated zinc ferrite particles in a weight ratio of carbon-coated zinc ferrite particles to carbon in the range from ≧1:10 to ≦40:1, preferably in the range from ≧7:3 to ≦20:1, and especially preferably in a weight ratio in the range from ≧3:1 to ≦4:1. Preferred carbon-containing materials are, for example, carbon black, synthetic or natural graphite, graphene, carbon nanoparticles, fullerenes, or mixtures thereof. One carbon black which can be used is available, for example, under the trade name Ketjenblack®. A carbon black which can be used with preference is available, for example, under the trade name Super P® and Super P Li®. The carbon-containing material may have an average particle size in the range from 1 nm to 500 μm, preferably from 5 nm to 1 μm, more preferably in the range from 10 nm to 60 nm. The average diameter of the carbon particles may be 20 μm or less, preferably 15 μm or less, more preferably 10 μm or less, more preferably in the range from 10 nm to 60 nm.

The fraction of carbon-coated zinc ferrite particles, based on the total weight of carbon-coated zinc ferrite particles, binder, and conductive carbon, is preferably in the range from ≧10 wt % to ≦98 wt %, more preferably in the range from ≧50 wt % to ≦95 wt %, very preferably in the range from ≧75 wt % to ≦85 wt %. The fraction of added conductive carbon, based on the total weight of the composite electrode made up of carbon-coated zinc ferrite particles, binder, and conductive carbon, is preferably in the range from ≧0 wt % to ≦90 wt %, more preferably in the range from ≧2 wt % to ≦50 wt %, very preferably in the range from ≧5 wt % to ≦20 wt %.

The composite electrode may further comprise binders. Suitable binders are, for example, poly(vinylidene difluoride-hexafluoropropylene) (PVDF-HFP) copolymer, polyvinylidene fluoride (PVDF), polyethylene oxide (PEO), styrene-butadiene rubber (SBR), carboxymethylcellulose (CMC), as for example sodium carboxymethylcellulose (Na-CMC), or polytetrafluoroethylene (PTFE), and cellulose, more particularly natural cellulose, and also suitable combinations of different binders. A preferred binder is carboxymethylcellulose (CMC), such as sodium carboxymethylcellulose (Na-CMC).

In preferred embodiments, the composite electrode comprises carboxymethylcellulose as binder. Carboxymethylcellulose is more eco-friendly and more cost-effective by comparison with binders used in customary commercial batteries. In particular, carboxymethylcellulose is water-soluble. Hence carboxymethylcellulose permits the use of water as a dispersion medium for electrode production, and hence removes the need for N-methylpyrrolidinone. Carboxymethylcellulose, moreover, in contrast to the use of fluorine-containing binders, allows easy recycling of the electrode materials at the end of the life cycle of the batteries, by simple pyrolysis, i.e., thermal decomposition of the binder material.

A particular surprise, furthermore, was that the use of the cellulose derivative carboxymethylcellulose (CMC) as binder material resulted in a significantly improved cycling stability and reversibility of the electrodes.

In preferred embodiments, the composite electrode, based on the total weight of carbon-coated zinc ferrite particles, binder, and optionally conductive carbon, has a binder fraction in the range from ≧1 wt % to ≦50 wt %, preferably in the range from ≧2 wt % to ≦15 wt %, more preferably in the range from ≧3 wt % to ≦10 wt %. The fraction of binder may for example be 5 wt %, based on the total weight of carbon-coated zinc ferrite particles, binder, and optionally conductive carbon. The dry weight of a mixture of carbon-coated zinc ferrite particles, binder, and conductive carbon may for example include 75 wt % of carbon-coated zinc ferrite particles, 20 wt % of conductive carbon black, and 5 wt % of binder, carboxymethylcellulose for example, based on the total weight of the mixture.

The production of an electrode may comprise the steps of mixing the carbon-coated zinc ferrite particles with carbon black, and mixing the solids mixture with a binder in solution in solvent—for example, carboxymethylcellulose in solution in water—and application of the mixture to a conductive substrate, and drying of the resulting electrodes. The mixture may be applied, for example, with a wet film thickness in the range from ≧20 μm to ≦2 mm, preferably in the range from ≧90 μm to ≦500 μm, more preferably in the range from ≧100 μm to ≦200 μm. The mass loading of the electrode may be in the range from ≧0.2 mg cm⁻² to ≦30 mg cm⁻², preferably in the range from ≧1 mg cm⁻² to ≦150 mg cm⁻², more preferably in the range from ≧2 mg cm⁻² to ≦10 mg cm⁻².

A further subject of the invention relates to a lithium-based energy storage device, preferably selected from the group encompassing a primary lithium battery, primary lithium-ion battery, secondary lithium-ion battery, primary lithium polymer battery, or lithium-ion capacitor, comprising an electrode based on carbon-coated zinc ferrite particles of the invention or carbon-coated zinc ferrite particles produced in accordance with the invention. The electrodes are suitable more particularly for primary lithium-ion batteries or secondary lithium-ion batteries.

In principle for the lithium-based energy storage device it is possible to use electrolytes, solvents, and conductive salts that are known to the skilled person, being commonly used in lithium-ion batteries. One preferred conductive salt is LiPF₆. A particularly preferred solvent for the electrolyte is a mixture of ethylene carbonate and diethyl carbonate.

Examples and figures which serve for illustrating the present invention are indicated hereinafter.

The figures, in this context, show the following:

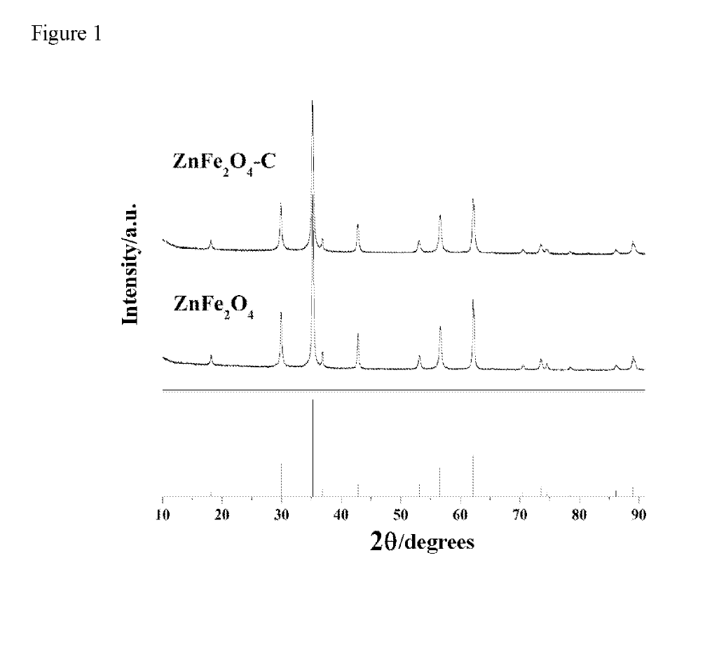

FIG. 1 shows X-ray diffractograms: at the top, the X-ray diffractogram of the resultant carbon-coated zinc ferrite particles; in the middle, that of the ZnFe₂O₄ nanoparticles used; and, at the bottom, the signals of the JCPDS (Joint Committee of Powder Diffraction Standards) file for the spinel ZnFe₂O₄.

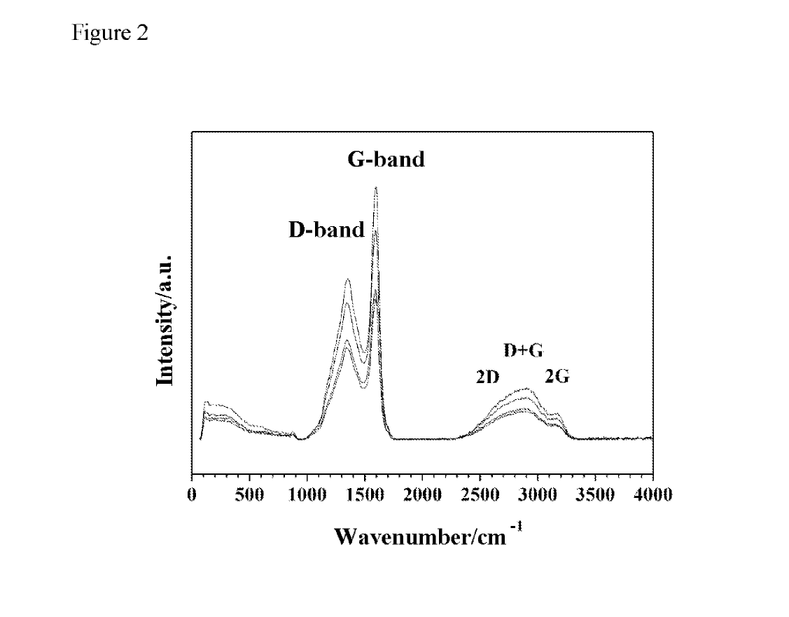

FIG. 2 shows Raman spectrographs of the carbon-coated zinc ferrite particles produced, recorded for four positions of the sample of the carbon-coated zinc ferrite particles produced.

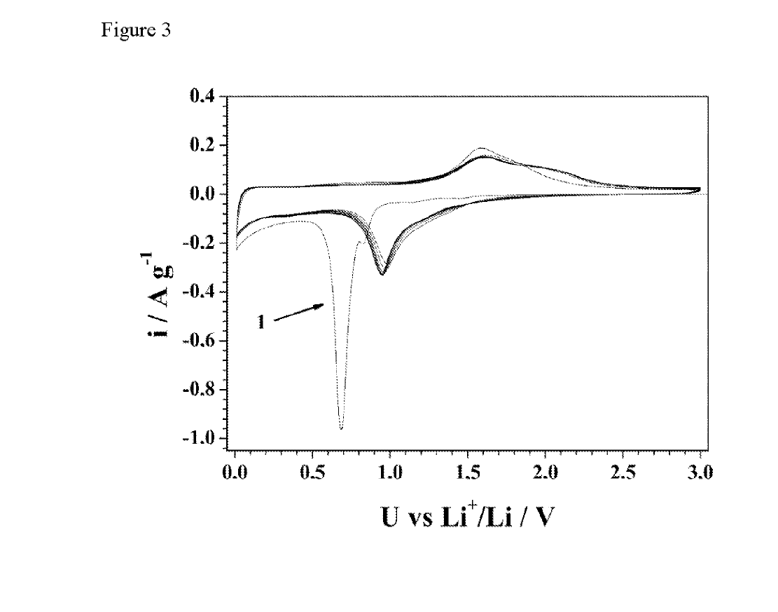

FIG. 3 shows a cyclovoltammogram of a composite electrode comprising carbon-coated zinc ferrite particles as anode with lithium metal as reference electrode and counterelectrode.

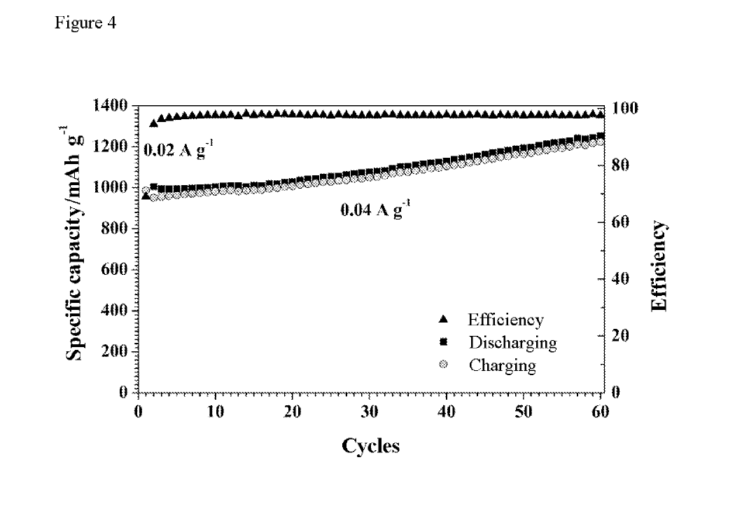

FIG. 4 shows the specific capacity of the carbon-coated zinc ferrite particles for an applied current density of 0.02 A g⁻¹ in the first cycle and 0.04 A g⁻¹ in the following cycles. The charge and discharge capacity (left-hand ordinate axis) and efficiency (right-hand ordinate axis) are plotted against the number of charge/discharge cycles.

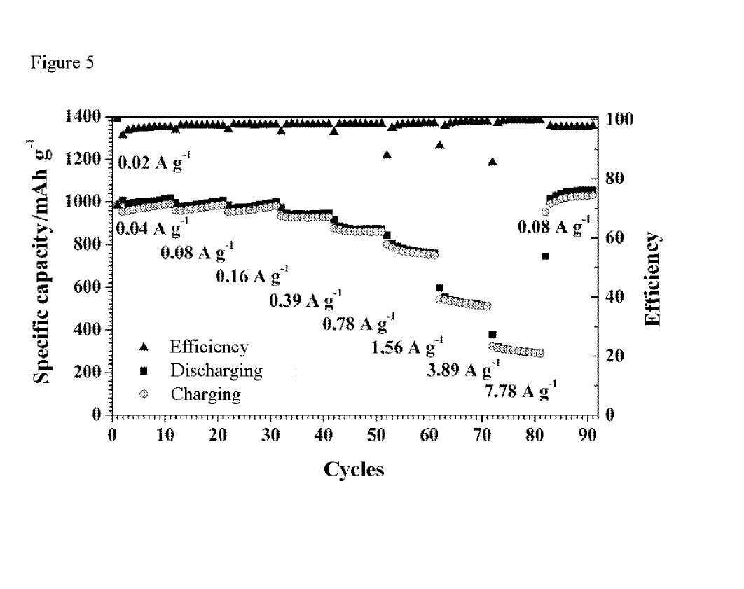

FIG. 5 shows the capacity characteristics of the composite electrode comprising carbon-coated zinc ferrite particles for increasing charge and discharge rates.

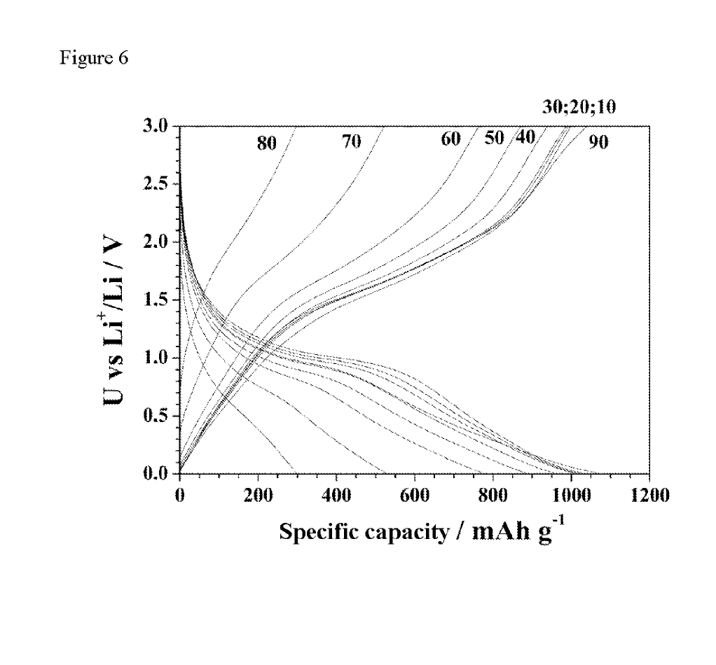

FIG. 6 shows the voltage profile of the carbon-coated zinc ferrite particles, plotted against the specific capacity for cycles 10, 20, 30, 40, 50, 60, 70, 80, and 90.

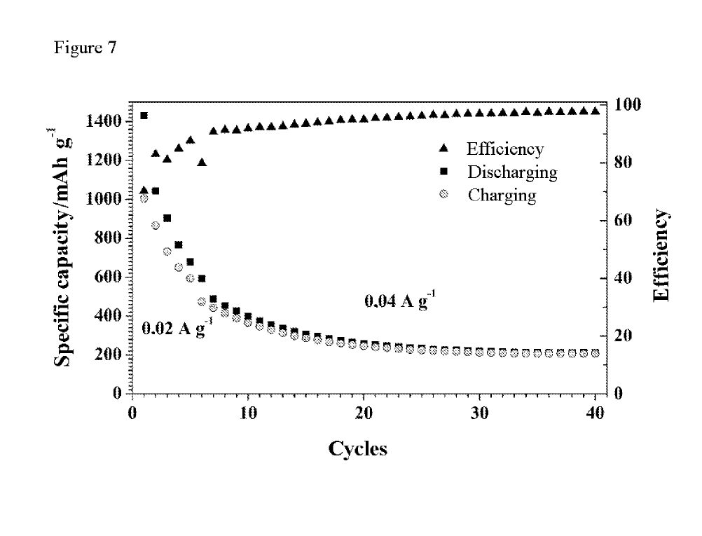

FIG. 7 shows the specific capacity of ZnFe₂O₄ particles for an applied current density of 0.02 A g⁻¹ in the first cycle and 0.04 A g⁻¹ in the following cycles. The charge and discharge capacity (left-hand ordinate axis) and efficiency (right-hand ordinate axis) are plotted against the number of charge/discharge cycles.

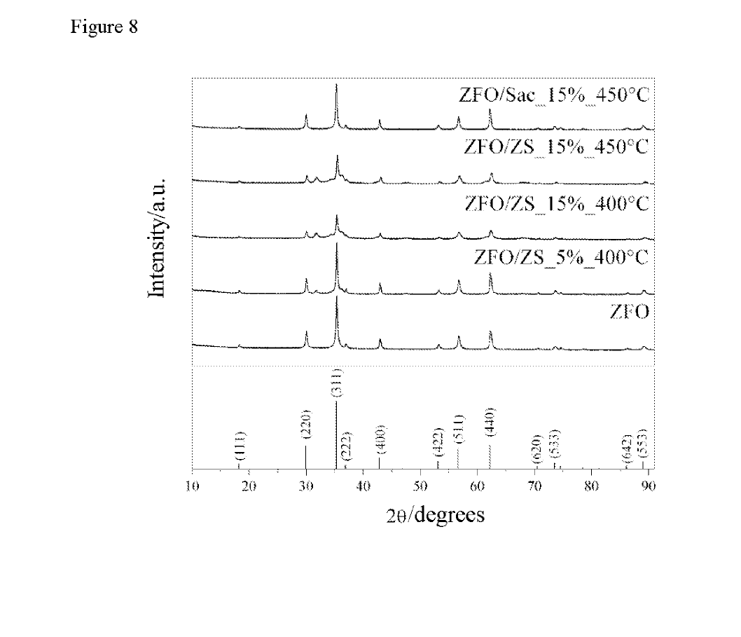

FIG. 8 shows X-ray diffractograms of carbon-coated zinc ferrite particles obtained by carbonizing with sucrose at a temperature of 450° C. according to a further embodiment (example 7) (ZFO/Sac_{—}15%_{—}450° C.), and also of carbon-coated zinc ferrite particles obtained by carbonizing with citric acid at temperatures of 400° C. and 450° C. according to example 8 (ZFO/ZS_{—}15%_{—}450° C., ZFO/ZS_{—}15%_{—}400° C., ZFO/ZS_{—}5%_{—}400° C.), of the zinc ferrite particles (ZFO) used, and also, below, the signals of the JCPDS file for ZnFe₂O₄.

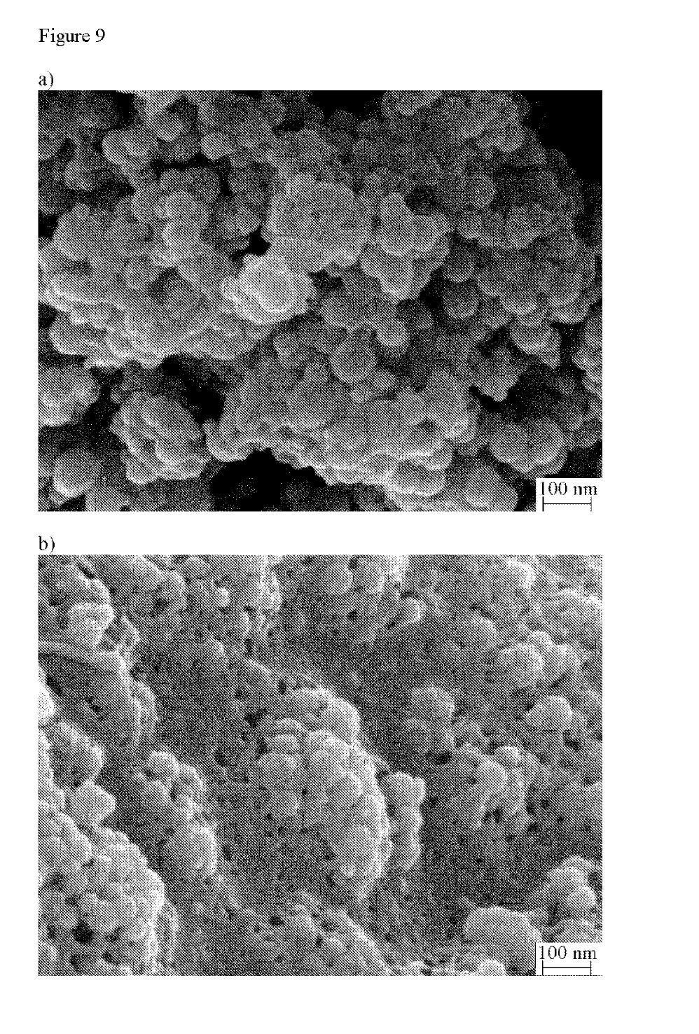

FIG. 9 shows scanning electron micrographs of the carbon-coated zinc ferrite particles prepared by carbonizing with sucrose at a temperature of 450° C., in FIG. 9a), and also, in FIG. 9b), of the carbon-coated zinc ferrite particles obtained by carbonizing with citric acid at a temperature of 400° C.

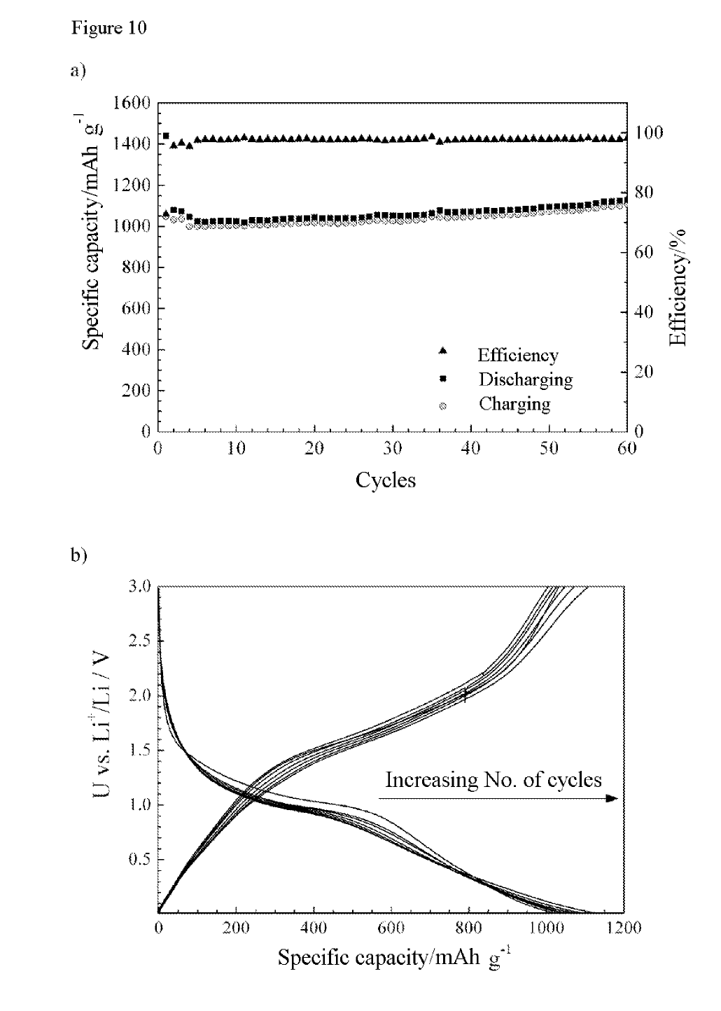

FIG. 10 shows the specific capacity and associated voltage profiles of carbon-coated zinc ferrite particles prepared by carbonizing with sucrose at a temperature of 450° C. FIG. 10a) shows the specific capacity at an applied current density of 0.05 A g⁻¹ in the first cycle and 0.1 A g⁻¹ in the following cycles. The charge and discharge capacity (left-hand ordinate axis) and efficiency (right-hand ordinate axis) are plotted against the number of charge/discharge cycles. FIG. 10b) shows selected voltage profiles, belonging to FIG. 10a), of the carbon-coated zinc ferrite particles, plotted against the specific capacity for cycles 2, 10, 20, 30, 40, 50, and 60.

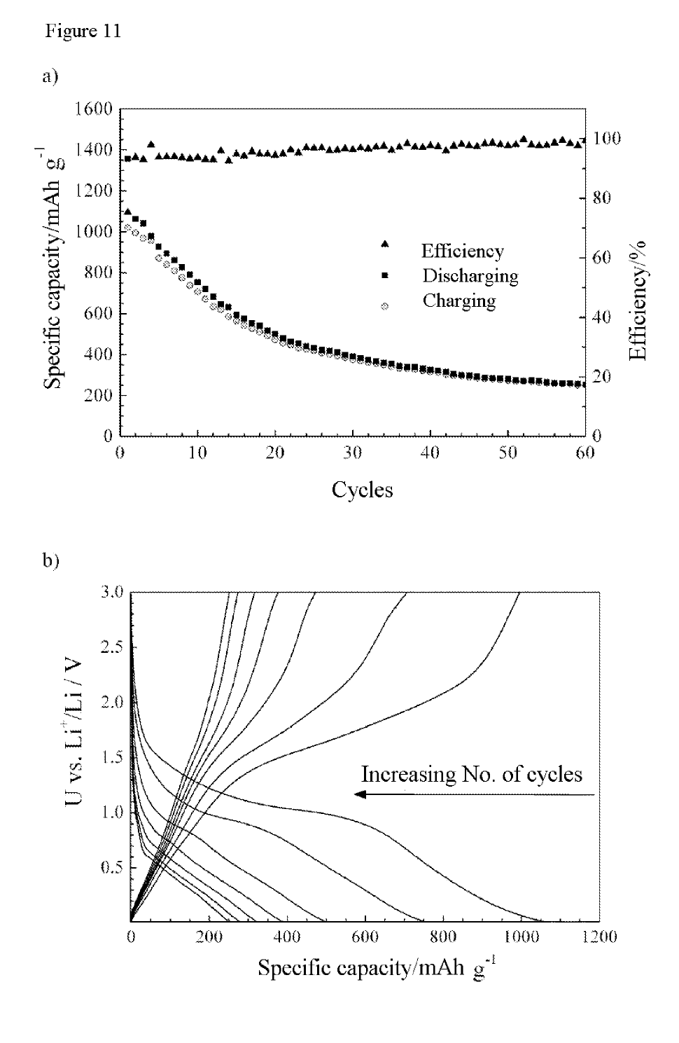

FIG. 11 shows the specific capacity and associated voltage profiles of carbon-coated zinc ferrite particles prepared by carbonizing with citric acid at a temperature of 400° C. according to example 9. FIG. 11a) shows the specific capacity at an applied current density of 0.05 A g⁻¹ in the first cycle and 0.1 A g⁻¹ in the following cycles. The charge and discharge capacity (left-hand ordinate axis) and efficiency (right-hand ordinate axis) are plotted against the number of charge/discharge cycles. FIG. 11b) shows selected voltage profiles, belonging to FIG. 11a), of the carbon-coated zinc ferrite particles, plotted against the specific capacity for cycles 2, 10, 20, 30, 40, 50, and 60.

### EXAMPLE 1

### Production of Carbon-Coated Zinc Ferrite Particles

For the production of the carbon-coated zinc ferrite particles, 0.75 g of sucrose (Sigma-Aldrich, 99.5% purity) was dissolved in 3.5 ml of deionized water (Millipore) with stirring with a magnetic stirrer. Then 1 g of ZnFe₂O₄ nanopowder (Sigma-Aldrich, <100 nm, >99% purity) was added and the mixture was homogenized in a ball mill (Vario-Planetary Mill Pulverisette 4, Fritsch) at 800 rpm for 1.5 hours. The resulting mixture was dried overnight in air at 80° C. and then heated in an argon atmosphere at 500° C. for 4 hours. During this treatment the temperature in the oven (R50/250/12, Nabertherm) was raised at 3° C. min⁻¹. Thereafter the carbon-coated zinc ferrite particles obtained were mortared manually.

The morphology and the particle size of the resultant carbon-coated zinc ferrite particles and also of ZnFe₂O₄ nanopowder used were determined by X-ray powder diffractometry (XRD) using a BRUKER D8 Advance (Cu-Kα radiation, λ=0.154 nm) X-ray diffractometer and high-resolution scanning electron microscopy (HRSEM) using a ZEISS Auriga® electron microscope.

FIG. 1 shows at the top the X-ray diffractogram of the resultant carbon-coated zinc ferrite particles, in the middle that of the ZnFe₂O₄ nanoparticles used, and at the bottom the signals of the JCPDS (Joint committee of Powder Diffraction Standards) file for the spinel ZnFe₂O₄ with Fd-3m space group (JCPDS 00-022-1012). As can be seen from FIG. 1, the signals observed for the carbon-coated zinc ferrite particles produced and for the zinc ferrite used were unambiguously assignable to the signals of ZnFe₂O₄. This shows the phase purity of the carbon-coated zinc ferrite particles produced. The absence of further bands such as graphitic carbon shows further that a coating of amorphous carbon has been formed.

The fraction of carbon was determined by thermogravimetric analysis (TGA) under O₂ (TA Instruments Q5000) to be 13.05 wt %, based on the total weight of the particles. Correspondingly, the fraction of ZnFe₂O₄ in the sample under analysis is 86.95 wt %. The weight ratio is therefore approximately 87:13.

The BET surface area was determined by determining the specific surface area of solids by gas adsorption by the Brunauer-Emmett-Teller (BET) method using an ASAP 2020 (Accelerated Surface Area and Porosimetry Analyzer, Micromeritics) by means of the adsorption of nitrogen. The BET surface area of the ZnFe₂O₄ nanoparticles used was 21.765 m² g⁻¹; the BET surface area of the carbon-coated zinc ferrite particles produced was 82.255 m² g⁻¹. This shows that the BET surface area of the particles has been increased significantly as a result of a high porosity of the carbon coating.

On the basis of calculations starting from the BET surface area and also from the theoretical density of the material, using the formula 2*3*1000/BET surface area/density, on the basis of an assumption of approximately spherical particles, the average diameter of the ZnFe₂O₄ nanoparticles employed came out at about 50 nm to 55 nm. This was confirmed by comparison with the scanning electron micrographs (ZEISS Auriga® electron microscope) of the untreated particles. Furthermore, the HRSEM micrographs of the carbon-coated zinc ferrite particles obtained showed no great changes of the particles in terms of their size distribution. It may therefore be assumed that the carbon coating has allowed particle agglomeration during the carbonizing step to be prevented.

FIG. 2 shows Raman spectrographs of the carbon-coated zinc ferrite particles produced. The spectrographs were made using a SENTERRA Raman spectrometer (BRUKER Optics), using a 532 nm laser and an output power of 2 mW. Four spectrographs were recorded for four positions of the sample of the carbon-coated zinc ferrite particles produced. As can be seen from FIG. 2, these spectrographs are extremely similar. This shows the high homogeneity of the carbon coating.

As may further be seen from FIG. 2, the Raman spectrum showed two peaks, known as the D- and G-bands, in the region of 1350 cm⁻¹ and 1585 cm⁻¹, which are characteristic of amorphous carbon. Furthermore, the Raman spectrum, in the region from 2400 cm⁻¹ to 3300 cm⁻¹, shows regions of increased intensity. Accordingly, carbon signals exclusively were detected. This shows that the ZnFe₂O₄ nanoparticles have been enveloped comprehensively by a carbon layer as a result of the carbonizing with sucrose.

### EXAMPLE 2

### Electrode Production

For electrode production, the carbon-coated zinc ferrite particles produced according to example 1 were used with conductive carbon and carboxymethylcellulose (CMC) as binder in a weight ratio of 75:20:5.

First of all, sodium carboxymethylcellulose (CMC, WALOCEL™ CRT 2000 PPA 12, Dow Wolff Cellulosics) was dissolved in deionized water, giving a solution containing 1.25 wt % of carboxymethylcellulose. To this, the particles produced according to example 1 and Super P® conductive carbon (TIMCAL®, Switzerland) as conductivity additive were added and the mixture was homogenized using a ball mill (Vario-Planetary Mill Pulverisette 4, Fritsch) at 800 rpm for 2 hours. The suspension thus obtained was applied with a doctor blade, with a wet film thickness of 120 μm, to copper foil (Schlenk). The electrode was dried in air at 80° C. for 2 hours and then at room temperature (20±2° C.) for 12 hours.

Subsequently, circular electrodes with a diameter of 12 mm and an area of 1.13 cm² were punched out and dried under reduced pressure at 120° C. for 12 hours. The mass loading was approximately 1.5 mg cm⁻². The mass loading was determined by weighing of the pure foil and of the electrodes punched out.

### EXAMPLE 3

### Production of a Comparative Electrode

For the production of the comparative electrode, ZnFe₂O₄ particles used for producing carbon-coated zinc ferrite particles according to example 1 were used, with conductive carbon and PVDF-HFP (polyvinylidene fluoride-hexafluoropropylene) copolymer as binder, in a weight ratio of 80:10:10.

First of all, PVDF-HFP copolymer (Kynarflex 2801, Arkema) corresponding to a final 10 wt %, based on the total weight of particles, conductive carbon, and binder, was dissolved in N-methylpyrrolidinone (Aldrich). To this, the ZnFe₂O₄ nanopowder (Sigma-Aldrich, <100 nm, >99% purity) used for producing the carbon-coated particles and Super P® conductive carbon (TIMCAL®, Switzerland) as conductivity additive were added and the mixture was homogenized using a ball mill (Vario-Planetary Mill Pulverisette 4, Fritsch) at 800 rpm for 2 hours. The suspension thus obtained was applied with a doctor blade, with a wet film thickness of 120 μm, to copper foil (Schlenk). The electrode was dried in air at 80° C. for 2 hours and then at room temperature (20±2° C.) for 12 hours.

Subsequently, circular electrodes with a diameter of 12 mm and an area of 1.13 cm² were punched out and dried under reduced pressure at 120° C. for 12 hours. The mass loading was approximately 1.4 mg cm⁻². The mass loading was determined by weighing of the pure foil and of the electrodes punched out.

### Electrochemical Investigations

The electrochemical investigation of the electrodes produced according to examples 2 and 3 took place in three-electrode Swagelok™ cells with lithium metal foils (Chemetall, battery grade purity) as counterelectrodes and reference electrodes. The cell was assembled in a glovebox (MBraun) filled with an inert argon gas atmosphere and having an oxygen and water content of less than 0.5 ppm. An electrolyte-impregnated stack of nonwoven polypropylene web (Freudenberg, FS2226) was used as separator in a 1 M solution of LiPF₆ as electrolyte in a 3:7 mixture, based on the weight, of ethylene carbonate and diethyl carbonate (battery grade purity, UBE, Japan).

Because lithium foil was used as counterelectrode and reference electrode, the reported voltages are based on the Li⁺/Li reference. All electrochemical investigations were conducted at 20° C.±2° C. The potentiostat/galvanostat used was a Maccor 4300 battery test system.

### EXAMPLE 4

### Cyclic Voltammetry

The cyclovoltammogram using the composite electrode produced according to example 2 and comprising carbon-coated zinc ferrite particles was recorded on a VMP3 multichannel potentiostat/galvanostat system (Biologic Science Instrument, France). Cycling took place for 10 cycles at a scan rate of 0.05 mV/s in the range from 0.01V to 3.0 V against lithium.

FIG. 3 shows the cyclovoltammogram of the composite electrode produced according to example 2, as anode, against lithium metal, as reference and counterelectrodes. From the signal at about 0.7 V against lithium it is evident that in the first cycle (1), zinc ferrite has been reduced to lithium oxide, zinc, and iron. The metallic zinc and further lithium-ions subsequently form a lithium-zinc alloy. In the course of the subsequent oxidation (cut-off potential 3.0 V), the corresponding oxides are then formed again. The shoulder of the first cycle (1) at about 0.7 V against lithium indicates the decomposition of ZnFe₂O₄ to form ZnO and FeO.

In the further cycles, as is apparent from FIG. 3, a reversible and stable cycling was made possible. The signals at about 1.6 V and about 2.1V indicate the conversion reactions LiZn→Li⁺+e⁻+Zn and Fe+Li₂O→2Li⁺+2e⁻+FeOₓO_{y}.

### EXAMPLE 5

### Electrochemical Investigation of the Electrode Comprising Carbon-Coated Zinc Ferrite Particles

In the first cycle, the cells were charged and discharged with a constant current density of 0.02 A/g to a cut-off potential of 0.01V or 3.0 V, respectively. In the subsequent cycles, a current density of 0.04 A/g was applied to the electrodes, and the cell was discharged to a potential of 0.01V and charged to 3.0 V.

FIG. 4 shows the specific capacity of the electrode for an applied current density of 0.02 A g⁻¹ in the first cycle and 0.04 A g⁻¹ in the subsequent cycles. The charge and discharge capacity is plotted on the left-hand ordinate axis, and the efficiency on the right-hand ordinate axis, against the number of charge/discharge cycles.

In FIG. 4 it can be seen that the capacity is constant over more than 60 cycles and in fact rises slightly in the course of cycles. Similar observations have already been reported for other transition metal oxides, and can be explained by the partially reversible formation of a polymeric layer on the particles.

FIG. 5 shows the capacity characteristics of the composite electrode comprising carbon-coated zinc ferrite particles for increasing charge and discharge rates. Even for an applied current density increased by a factor of 10, the resulting electrodes showed a stable capacity of around 930 mAh g⁻¹. For a further ten-fold increase in the applied current density (3.89 A g⁻¹), a capacity of about 530 mAh g⁻¹ was obtainable, and is still far above the theoretical capacity of graphite used in commercial cells (372 mAh g⁻¹). This is particularly remarkable in view of the fact that the applied current density corresponds to a C rate of 10C based on graphite; accordingly, a graphite-based cell could be charged or discharged 10 times within 1 hour. Generally speaking, however, graphite-based electrodes cannot be charged and discharged in such a short time, or only with a significantly reduced capacity. Even for an applied current density of about 7.78 A g⁻¹, it was possible to obtain a reversible capacity of about 310-320 mAh g⁻¹, comparable with the theoretical capacity of graphite for low applied current densities (about 0.37 Ah g⁻¹).

The electrodes therefore exhibited very good capacity characteristics at high charge and discharge rates. It is notable, furthermore, that the full capacity of the electrode could be recovered subsequent to the C rate test, and hence that the original structure of the material has not experienced any relevant alterations.

FIG. 6 shows the corresponding voltage profile plotted against the specific capacity for the 10th, 20th, 30th, 40th, 50th, 60th, 70th, 80th, and 90th cycles. As can be seen from FIG. 6, the electrode based on carbon-coated zinc ferrite particles exhibited a very high reversible capacity of more than 1000 mAh g⁻¹. From the voltage profile, particularly for increasing current densities, it is apparent that the internal resistance of the cell increased significantly only for cycles 70 and 80, corresponding to a current density of 3.89 A g⁻¹ and 7.78 A g⁻¹, but was mostly constant for lower current densities. This explains the extremely stable capacity of the electrode.

### EXAMPLE 6

### Electrochemical Investigation of the Comparative Electrode

For the electrochemical investigation of the comparative electrode produced according to example 3, the cells in the first cycle were charged and discharged with a constant current density of 0.02 A/g to a cut-off potential of 0.01V and 3.0 V, respectively. In the subsequent cycles, a current density of 0.04 A/g was applied to the electrodes, and the cell was discharged to a potential of 0.01V and charged to 3.0 V.

FIG. 7 shows the specific capacity of the comparative electrode for an applied current density of 0.02 A g⁻¹ in the first cycle and 0.04 A g⁻¹ in the subsequent cycles. The charge and discharge capacity is plotted on the left-hand ordinate axis, and the efficiency on the right-hand ordinate axis, against the number of charge/discharge cycles. In FIG. 7 it is apparent that the charge/discharge efficiency of the comparative electrode is relatively low. In addition, the capacity obtained drops off immediately and rapidly to only about 200 mAh g⁻¹ after 30 cycles.

Overall, the results of the electrochemical investigations show that the electrodes based on carbon-coated zinc ferrite particles exhibit very good results, by comparison with the ZnFe₂O₄ nanoparticles employed, in respect of a combination of reversible capacity, charge and discharge efficiency, and cycling stability.

It was found in particular that the use of carboxymethylcellulose (CMC) as binder material led to a significantly improved cycling stability and reversibility of the electrodes.

The results therefore show that the carbon-coated zinc ferrite particles are able to provide an advantageous anode material with a high cycling stability. The electrodes, in particular, exhibited very good electrochemical performance for applied high current densities, and full recovery of the original capacity following increased applied current densities.

### EXAMPLE 7

### Production of Carbon-Coated Zinc Ferrite Particles at a Carbonizing Temperature of 450° C.

0.75 g of sucrose (Acros Organics) was dissolved in 1.5 ml of deionized water (Millipore) with stirring with a magnetic stirrer. Then 1 g of ZnFe₂O₄ powder (Sigma-Aldrich, <100 nm, >99% purity) was added. The mixture was homogenized for 1.5 hours in a ball mill (Vario-Planetary Mill Pulverisette 4, Fritsch) at 800 rpm. The resulting mixture was dried in air at 70° C. overnight and then heated in an argon atmosphere at 450° C. for 4 hours. During this treatment the temperature in the oven (R50/250/12, Nabertherm) was raised at 3° C. min⁻¹. Thereafter the carbon-coated zinc ferrite particles obtained were mortared manually.

The morphology of the resultant carbon-coated zinc ferrite particles was determined by X-ray powder diffractometry (XRD, BRUKER D8 Advance (Cu-Kα radiation, λ=0.154 nm)). FIG. 8 shows at the top the X-ray diffractogram of the resultant carbon-coated zinc ferrite particles. As can be seen from FIG. 8, they were in good agreement with the signals of ZnFe₂O₄. No additional signals were detected. This shows that no changes have occurred in the structure as a result of the carbonizing.

The fraction of carbon was determined by thermogravimetric analysis (TGA) in an oxygen atmosphere (TA Instruments Q 5000) to be 16.6 wt %, based on the total weight of the resultant, coated particles. Correspondingly, the fraction of ZnFe₂O₄ in the sample under analysis was 83.4 wt %. The weight ratio was therefore approximately 83:17.

The BET surface area was determined by determination the specific surface area by gas adsorption according to the Brunauer-Emmett-Teller (BET) method, using an ASAP 2020 (Accelerated Surface Area and Porosimetry Analyzer, Micromeritics) by means of the adsorption of nitrogen. The BET surface area of the carbon-coated zinc ferrite particles was 82.6 m² g⁻¹. Relative to the 20.7 m² g⁻¹ determined for the BET surface area of the ZnFe₂O₄ particles employed, therefore, the carbon coating produced a significant increase in this surface area.

The homogeneity of the carbon coating was investigated by means of Raman spectroscopy (Bruker Optics, Senterra), using a 532 nm laser and an output power of 10 mW. As compared with that of the zinc ferrite particles employed, the Raman spectrum showed two intense new bands at about 1354 cm⁻¹ and 1595 cm⁻¹, which are characteristic of amorphous carbon. Exclusively carbon signals were detected, but no signals of zinc ferrite, which shows that the ZnFe₂O₄ particles were covered, as a result of the carbonizing with sucrose, with a homogeneous layer of carbon. Furthermore, FIG. 9a) shows a scanning electron micrograph (Carl Zeiss Auriga® HRSEM) of the carbon-coated zinc ferrite particles. The micrograph shows a particle size and particle shape corresponding to that of the uncoated particles. This confirms that the carbon coating applied by carbonizing with sucrose has been applied homogeneously to the particles.

### COMPARATIVE EXAMPLE 8

### Comparative Experiments on the Coating of Zinc Ferrite Particles with Carbon Using Citric Acid

Citric acid, as a carbon-containing organic compound, is likewise suitable for carbonizing. The production of carbon-coated zinc ferrite particles using citric acid took place as described in example 7, but with carbonization in three batches of 1 g of ZnFe₂O₄ powder, in each case with 3.38 g of citric acid (Grüssing), at 400° C. and 450° C., and also with 1.12 g of citric acid at 400° C.

The morphology, carbon fraction, BET surface area, and homogeneity of the carbon coating were determined likewise as described in example 7.

FIG. 8 shows in the middle the X-ray diffractograms of the particles carbonized with citric acid (ZS). Here, not only in the case of the particles carbonized at 450° C. and 400° C. in a weight ratio of 1:3.38 with critic acid (ZFO/ZS_{—}15%_{—}450° C. and ZFO/ZS_{—}15%/400° C.) but also in the case of the particles carbonized at 400° C. in a weight ratio of 1:1.12 with citric acid (ZFO/ZS_{—}5%_{—}400° C.), relative to the signals of ZnFe₂O₄, further signals were detected at 32°, 36°, and 42°, and were assigned to hexagonal ZnO and FeO in wuestite structure.

A comparison of the X-ray diffractograms shows carbonizing with sucrose to have the advantage over citric acid in that the considerable phase impurities, occurring even at relatively low temperatures, can be avoided.

Using TGA, the fraction of carbon in the particles carbonized with citric acid at 400° C. and 450° C. was found to be 15.51 wt % and 14.64 wt %, respectively, based on the total weight of the particles, while the fraction of carbon in the particles carbonized at 400° C. with citric acid in a weight ratio of 1:1.12 was found to be 5.4 wt %, based on the total weight of the particles. The BET surface area was 18.7 m² g⁻¹, 27.6 m² g⁻¹, and 33.4 m² g⁻¹, respectively. This shows a comparable fraction of carbon, relative to the use of sucrose, for particles carbonized with citric acid at 450° C. in a weight ratio of 1:3.38. However, on account of an uneven distribution of the carbon and also of a significant extent of particle agglomeration, the BET surface area is much lower, as can also be seen from the SEM micrographs for the sample containing 5.4 wt % of carbon (FIG. 9b)).

Furthermore, in addition to the carbon bands, the Raman spectra of the zinc ferrite particles coated with carbon using citric acid likewise still showed signals from zinc ferrite. This shows that the ZnFe₂O₄ particles have been only partly covered with a layer of carbon as a result of the carbonizing with citric acid. The scanning electron micrograph shown in FIG. 9b) for the particles carbonized with citric acid in a weight ratio of 1:1.12 at 400° C. also shows an uneven distribution of the remaining carbon when using citric acid as starting substance for the carbonizing, as is likewise reflected in the BET surface area of the material.

These results show that coating with carbon using sucrose, in contrast to using citric acid, is able to provide a homogeneous coating and a significantly increased BET surface area.

### EXAMPLE 9

### Electrode production

Electrode production took place as described in example 2, but using the zinc ferrite particles coated with carbon using sucrose, according to example 7, and also using, for comparison, the particles produced according to example 8 at a temperature of 400° C. using 1.12 g of citric acid (with about 5.4 wt % of carbon remaining, based on the total weight of the particles). These particles exhibited the least phase impurities and were therefore selected for the electrochemical investigation.

The carbon-coated zinc ferrite particles were used in each case with conductive carbon and carboxymethylcellulose (CMC) as binder in a weight ratio of 75:20:5. First of all, sodium carboxymethylcellulose (CMC, Dow Wolff Cellulosics) was dissolved in deionized water to give solutions containing 1.25 wt % of carboxymethylcellulose. To this, the particles produced according to examples 7 and 8 and Super P® conductive carbon (TIMCAL®, Switzerland) as conductivity additive were added and the mixtures were homogenized using a ball mill (Vario-Planetary Mill Pulverisette 4, Fritsch) for four times 30 minutes at 400 and 800 rpm, with a 10-minute pause in between. The resulting suspensions were applied using a doctor blade, with a wet film thickness of 120 μm, to copper foil (Schlenk). The electrodes were dried in air at 80° C. for 10 minutes and then at room temperature (20±2° C.) for 12 hours.

Subsequently, circular electrodes with a diameter of 12 mm, or an area of 1.13 cm², were punched out and dried under reduced pressure at 120° C. for 24 hours. The mass loading was determined by weighing the pure foil and the punched-out electrodes, and was in the range from 1.6 mg to 2.4 mg.

### EXAMPLE 10

### Electrochemical Investigation of the Electrode Comprising Carbon-Coated Zinc Ferrite Particles Based on the Use of Sucrose as Reactant and on Subsequent Carbonizing at 450° C.

In the first cycle, the cells were discharged and charged with a constant current density of 0.05 A/g to a cut-off potential of 0.01V and 3.0 V, respectively. In the subsequent cycles, a current density of 0.1 A/g was applied to the electrodes, and the cell was discharged to a potential of 0.01V and charged to 3.0 V. Since lithium foil was used as counterelectrode and reference electrode, the reported voltages are based on the Li⁺/Li reference. All electrochemical investigations were conducted at 20° C.±2° C. The potentiostat/galvanostat used was a Maccor 4300 battery test system.

FIG. 10a) shows the specific capacity of the electrode for an applied current density of 0.05 A g⁻¹ in the first cycle and 0.1 A g⁻¹ in the subsequent cycles. The charge and discharge capacity is plotted on the left-hand ordinate axis, and the efficiency on the right-hand ordinate axis, against the number of charge/discharge cycles. In FIG. 10a) it can be seen that the capacity was constant over 60 cycles or increased slightly in the course of cycles. Comparable characteristics were likewise observed for the particles carbonized with sucrose at 500° C. (cf. FIG. 4).

FIG. 10b) shows selected voltage profiles in relation to FIG. 10a), plotted against the specific capacity for the 2nd, 10th, 20th, 30th, 40th, 50th, and 60th cycles. As can be seen from FIG. 10b), the electrode based on carbon-coated zinc ferrite particles, starting from sucrose as reactant, exhibited a very high reversible capacity of more than 1000 mAh g⁻¹. It is apparent, moreover, that the electrochemical reaction, depicted through the voltage profile, ran extremely reversibly over all the cycles. This explains the extremely stable capacity of the electrode.

### COMPARATIVE EXAMPLE 11

### Electrochemical Investigation of the Comparative Electrode Comprising Carbon-Coated Zinc Ferrite Particles Based on the Use of Citric Acid as Reactant and on Subsequent Carbonizing at 400° C.

In analogy to example 10, in the first cycle, the cells were discharged and charged with a constant current density of 0.05 A/g to a cut-off potential of 0.01V and 3.0 V, respectively. In the subsequent cycles, a current density of 0.1 A/g was applied to the electrodes, and the cell was discharged to a potential of 0.01V and charged to 3.0 V. Since lithium foil was used as counterelectrode and reference electrode, the reported voltages are based on the Li⁺/Li reference. All electrochemical investigations were conducted at 20° C.±2° C. The potentiostat/galvanostat used was a Maccor 4300 battery test system.

FIG. 11a) shows the specific capacity of the comparative electrode for an applied current density of 0.05 A g⁻¹ in the first cycle and 0.1 A g⁻¹ in the subsequent cycles. The charge and discharge capacity is plotted on the left-hand ordinate axis, and the efficiency on the right-hand ordinate axis, against the number of charge/discharge cycles. In FIG. 11a) it can be seen that the resultant capacity fell off rapidly and continuously to only about 200 to 250 mAh g⁻¹ after 60 cycles. In addition, the charge/discharge efficiency of the comparative electrode was relatively low.

FIG. 11b) shows selected voltage profiles in relation to FIG. 11a), plotted against the specific capacity for the 2nd, 10th, 20th, 30th, 40th, 50th, and 60th cycles. As can be seen from FIG. 11b), the electrode based on carbon-coated zinc ferrite particles, starting from citric acid as reactant, exhibited a specific capacity which drops sharply in the course of cycles, owing to a rapidly increasing internal resistance and also to the loss of the voltage profile, characteristic of zinc ferrite particles, for the electrochemical reaction with lithium-ions. The latter two points explain the significant decrease in the specific capacity in the course of cycles.

The results therefore show that the use of a sugar, more particularly sucrose, for the production of carbon-coated zinc ferrite particles, surprisingly, has a significant effect on the morphology of the carbon-coated zinc ferrite particles and in particular on the electrochemical performance, with regard to the achievable, reversible, specific capacity and also the cycling stability of the electrodes based on these particles.

1. Carbon-coated zinc ferrite particles, wherein the weight ratio of zinc ferrite to carbon is from ≧75:25 to ≦99:1.

2. A method for producing carbon-coated zinc ferrite particles, comprising the following steps:
a) mixing ZnFe₂O₄ particles with a sugar, and
b) carbonizing the mixture from step a).

3. The method as claimed in claim 2, wherein the sugar is a mono-, di- or polysaccharide.

4. The method as claimed in claim 2, wherein the carbonizing is performed at a temperature of from ≧350° C. to ≦700° C.

5. Carbon-coated zinc ferrite particles as claimed in claim 1, the particles obtained by a method as claimed in claim 2.

6. (canceled)

7. An electrode material for lithium-based energy storage devices, comprising carbon-coated zinc ferrite particles as claimed in claim 1.

8. An electrode comprising carbon-coated zinc ferrite particles as claimed in claim 1.

9. The electrode as claimed in claim 8, which is a composite electrode comprising the carbon-coated zinc ferrite particles and a binder.

10. A lithium-based energy storage device comprising an electrode as claimed in claim 8.

11. The carbon-coated zinc ferrite particles as claimed in claim 1, wherein the weight ratio of zinc ferrite to carbon is from ≧80:20 to ≦98:2 or from ≧85:15 to ≦95:5.

12. The method as claimed in claim 2, wherein the sugar is selected from the group consisting of glucose, fructose, sucrose, lactose, starch, cellulose and derivatives thereof.

13. The method as claimed in claim 2, wherein the sugar is sucrose.

14. The method as claimed in claim 2, wherein the carbonizing is performed at a temperature of from ≧400° C. to ≦600° C. or from ≧450° C. to ≦550° C.

15. The electrode as claimed in claim 9, further comprising a conductive carbon.

16. The electrode as claimed in claim 9, wherein the binder is carboxymethylcellulose.

17. The lithium-based energy storage device as claimed in claim 10, which is a primary lithium battery, a primary lithium-ion battery, a secondary lithium-ion battery, a primary lithium polymer battery, or a lithium-ion capacitor.

18. The electrode material for lithium-based energy storage devices as claimed in claim 7, which is obtained by a method as claimed in claim 2.
